(19) United States
(12) Patent Application Publication
(10) Pub. No.: US 2018/0180159 A1
(43) Pub. Date: Jun. 28, 2018

(54) MODIFIED VEHICLE-USED CRANKSET COMPOSITE STRUCTURE

(71) Applicant: D.MAG(KUNSHAN)NEW MATERIAL TECHNOLOGY CO., LTD., Suzhou (CN)

(72) Inventor: Jibing Tu, Suzhou (CN)

(21) Appl. No.: 15/454,995

(22) Filed: Mar. 9, 2017

(30) Foreign Application Priority Data
Dec. 23, 2016 (CN) 201611203176.2

(51) Int. Cl. F16H 55/30; F16H 55/06; B62M 9/00

(52) U.S. Cl. CPC F16H 55/30; B62M 9/00; F16H 55/06

(57) ABSTRACT

A modified vehicle-used crankset composite structure, comprising an inner ring piece made from a lightweight metal and a tooth ring; the inner ring surface of the inner ring piece is equally divided and extends to form a plurality of arm-like fixing portions in the radial direction; the outer edge of the inner ring piece is equally divided to form a plurality of the first tooth portion in the radial direction; the two side surfaces of the first tooth portion respectively form a first engaging surface; a second engaging surface is disposed on one side surface of the tooth ring; the outer edge of the tooth ring is equally divided to form a plurality of the second tooth portions.

### TECHNICAL FIELD OF THE INVENTION

The present invention relates to the technical field of vehicles, and more particularly, to a modified vehicle-used crankset composite structure.

### BACKGROUND OF THE INVENTION

A bicycle is considered a lightweight vehicle that is human-powered and pedal-driven. The drivetrain begins with pedals which rotate the chain and the crankset, enabling the wheels to rotate to move forward. In the prior art, the bicycle crankset is integrally molded, and the molding material is typically hard iron. Along with the trend of lightweight design, the traditional iron-made crankset is gradually replaced by the crankset made from aluminum alloy.

Aluminum alloy is light, but not very rigid. Furthermore, the aluminum alloy is less durable than steel. A steel-made crankset can bear an infinite cyclic load. On the other hand, the fatigue limit of aluminum alloy is near zero, meaning that a very small cyclic load can damage the crankset made from aluminum alloy. During the movement, the point where the tooth portions of the crankset and the bicycle chain are engaged can easily be worn off. Consequently, the functional life of the crankset is sharply decreased if the rigidity and the wear-resistance of the tooth portions are not high enough.

Thus, maintaining the high rigidity and wear-resistance of the tooth portions as well as to achieving a lightweight crankset are urgent problems that need to be solved for those skilled in this field.

### SUMMARY OF THE INVENTION

The purpose of the present invention is to solve the shortcomings in the prior art, and provide a modified vehicle-used crankset composite structure.

To achieve the above purpose, the present invention adopts the following technical solution:

A modified vehicle-used crankset composite structure, comprising an inner ring piece made from a lightweight metal. The inner surface of the inner ring piece is equally divided and extends to form a plurality of arm-like fixing portions in the radial direction. The outer edge of the inner ring piece is equally divided to form a plurality of the first tooth portions in the radial direction. The two side surfaces of the first tooth portion form a first engaging surface.

The modified vehicle-used crankset composite structure further comprises a tooth ring made from a rigid, heat-resistant and wear-resistant material. A second engaging surface is disposed on one side surface of the tooth ring. The outer edge of the tooth ring is equally divided to form a plurality of the second tooth portions. An inner ring hole is disposed in the middle of the tooth ring. The two side surfaces of the inner ring piece are respectively pressed by the two tooth rings, enabling the second engaging surface to correspond to the first engaging surface of the inner ring piece. The inner ring piece and the two tooth rings are fixed via friction welding method forming the crankset.

In another aspect of the present invention, a protruding step structure is disposed between the outer edge of the inner ring piece and the first tooth portion of the inner ring piece. The two side surfaces of the first tooth portion of the inner ring piece respectively form a first engaging surface. A first engaging portion, which is inwardly recessed, is disposed on the outer edge of the two sides of the inner ring piece. A hole is disposed on the first engaging portion in the radial direction. An inner ring hole is disposed in the middle of the tooth ring. A plurality of the protruding second engaging portions is integrally disposed on the tooth ring near the inner ring hole. A plurality of protruding portion is disposed on one side of the second engaging portion along the radial direction, enabling the two side surfaces of the inner ring piece to be respectively engaged with the two tooth rings. The second engaging portion of the two tooth rings is engaged with the first engaging portions, and the protruding portion on each side is respectively inserted into one side of the corresponding hole, enabling the second engaging surfaces of the two tooth rings to be fixed to the first engaging surfaces of the corresponding side of the inner ring piece via friction a welding method.

In another aspect of the present invention, a side edge is disposed along the radial direction on one side surface of the tooth portion of the tooth ring which faces towards the inner ring piece. The second engaging surface is tightly attached to the first engaging surface, and the first tooth portion of the inner ring piece is covered by the corresponding side edges on the two sides, enabling the second engaging surface of the two tooth rings and the first engaging surface of the two sides of the inner ring piece, as well as the corresponding side edges, to be fixed via friction a welding method.

In another aspect of the present invention, the inner ring piece is made from a lightweight metal such as aluminum alloy, magnesium alloy or titanium alloy.

In another aspect of the present invention, the tooth ring is made from stainless steel.

In another aspect of the present invention, the tooth ring is made from heat-treated steel or iron.

In another aspect of the present invention, the tooth ring is made from a metal coated with Teflon or other wear-resistant material.

Compared with the prior art, the present invention has the following advantages:

The two tooth rings are tightly attached to the two side surfaces of the inner ring piece. Consequently, the overall weight of the crankset is significantly reduced due to the lightweight inner ring piece. Meanwhile, the tooth ring engaged with the bicycle chain is made from a material having a high rigidity, wear resistance and heat resistance, greatly prolonging the functional life of the tooth ring, improving the structural rigidity, and lowering the replacement frequency of the crankset. Thus, the user can feel safe when using the present invention. The outer edge of the two sides of the inner ring piece is provided with a plurality of the inwardly-recessed first engaging portions, and the first engaging portion is provided with a hole in the radial direction. Meanwhile, a plurality of the protruding second engaging portion is integrally disposed on the tooth ring near the inner ring hole, and one side of the second engaging portion is provided with a protruding portion in the radial direction. During assembly, the second engaging portion is embedded into the first engaging portion, and the protruding portions are respectively inserted into the holes, enabling the two tooth rings to be tightly engaged with the first engaging surface of the inner ring piece via a friction welding method. Through the engagement between the first engaging portion and the second engaging portion, and the engagement between the holes and protruding portions, the twisting force can be greatly improved, thereby achieving a stable structure. Furthermore, a side edge is disposed on one side surface of the second tooth portion of the tooth ring near the inner ring piece. When the second engaging surface is tightly engaged with the first engaging surface, the first tooth portion of the inner ring piece can be covered by the side edge of the two sides of the second tooth portion, enabling the two tooth rings to be fixed to the inner ring piece via a friction welding method. Thus, the binding force is greatly improved and the invention can be assembled more securely.

### BRIEF DESCRIPTION OF THE DRAWINGS

To clearly expound the present invention or technical solution, the drawings and embodiments are hereinafter combined to illustrate the present invention. Obviously, the drawings are merely some embodiments of the present invention and those skilled in the art can associate themselves with other drawings without paying creative labor.

FIG. 1 is a perspective view of the first embodiment of the present invention.

FIG. 2 is an exploded perspective view of the first embodiment of the present invention.

FIG. 3 is a front view of the first embodiment of the present invention.

FIG. 4 is a sectional view taken along line 4-4 of FIG. 3.

FIG. 5 is a perspective view of the second embodiment of the present invention.

FIG. 6 is exploded perspective view of the second embodiment of the present invention.

FIG. 7 is a front view of the second embodiment of the present invention.

FIG. 8 is a sectional view taken along line 8-8 of FIG. 7.

### DETAILED DESCRIPTION OF THE INVENTION

Drawings and detailed embodiments are combined hereinafter to elaborate the technical principles of the present invention.

### Embodiment 1

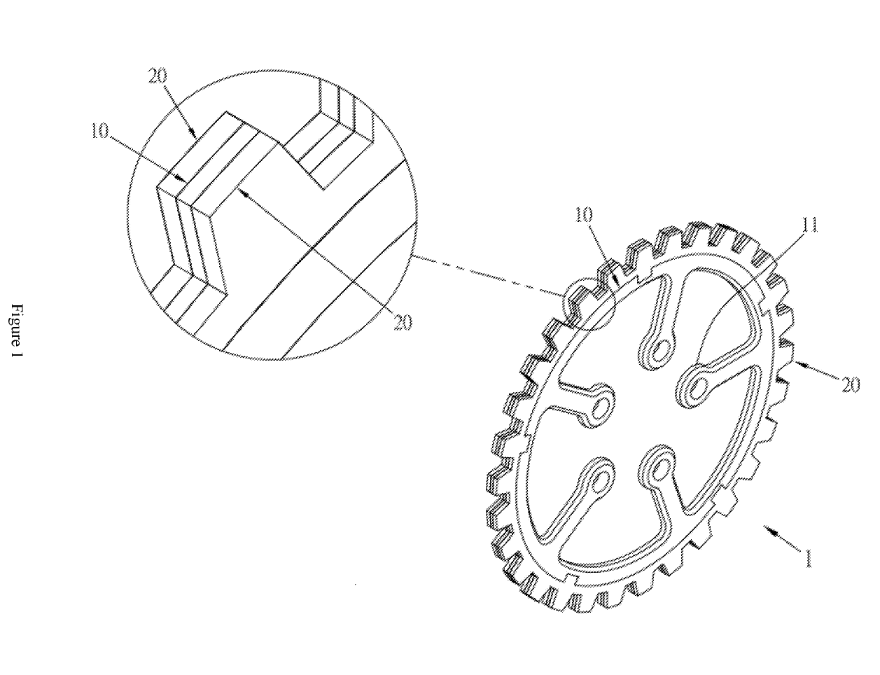

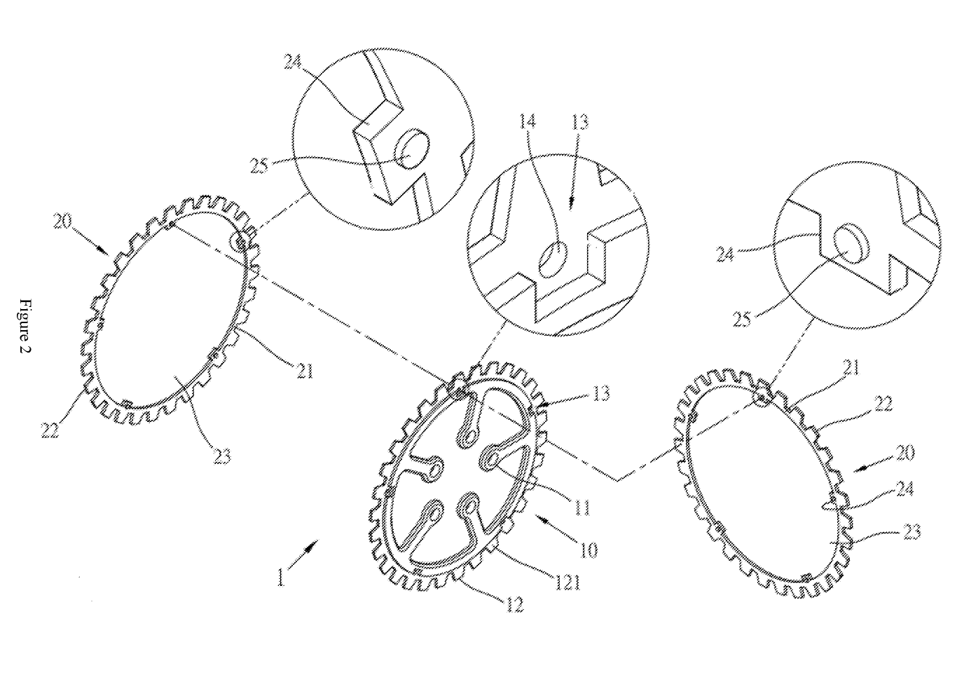

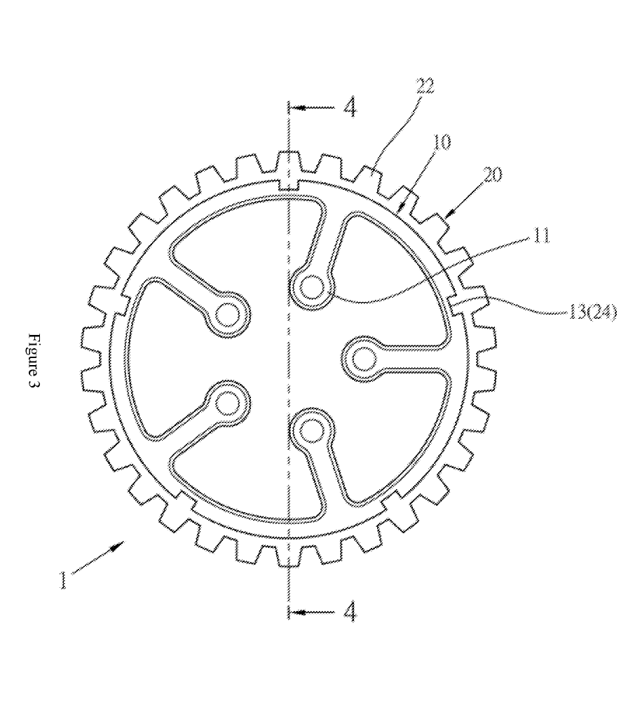

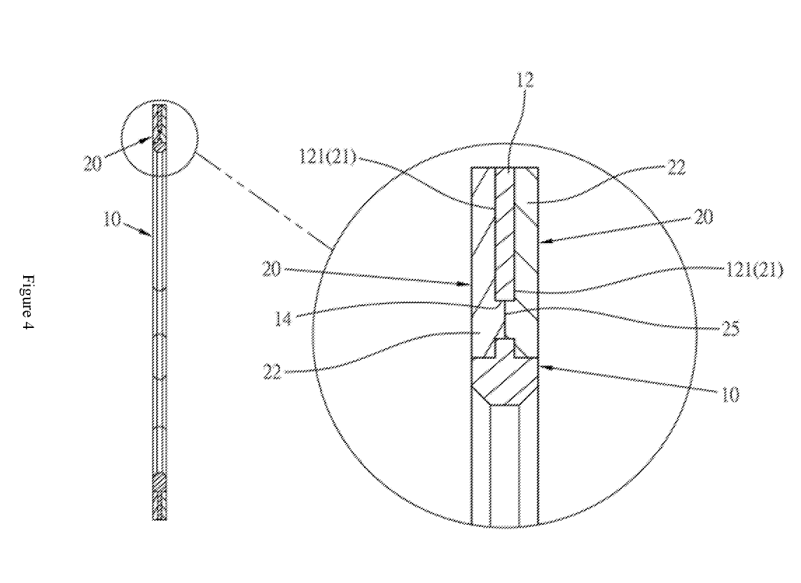

As shown in FIGS. 1-4, the crankset 1 comprises an inner ring piece 10 and a tooth ring 20. The inner surface of the inner ring piece 10 is equally divided to form a plurality of arm-like fixing portions 11 along the radial direction, through which the crankset 1 can be fixed to the frame of the bicycle. The outer edge of the inner ring piece 10 is equally divided to form a plurality of the first tooth portion 12 along the radial direction, and a protruding step structure is disposed between the outer edge of the inner ring piece 10 and the first tooth portion 12. The two side surfaces of the first tooth portion 12 are respectively provided with a first engaging surface 121. A plurality of the inwardly-recessed first engaging portions 13 is disposed on the outer edges of the two sides of the inner ring piece 10. The first engaging portions 13 are provided with the holes 14 along the radial direction. The inner ring piece 10 is made from a lightweight metal such as aluminum alloy, magnesium alloy or titanium alloy.

One side surface of the tooth ring 20 is the second engaging surface 21. The outer edge of the tooth ring 20 is equally divided to form a plurality of the second tooth portions 22. An inner ring hole 23 is provided in the middle of the tooth ring 20. A plurality of the protruding second engaging portions 24 is integrally provided on one side of the tooth ring 20 near the inner ring hole 23. One side of the second engaging portion 24 is provided with a protruding portion 25 in the radial direction. The tooth ring 20 is made from a rigid, heat-resistant and wear-resistant material, such as stainless steel, heat-treated steel/iron, or metal coated with Teflon or other wear-resistant material, which can effectively improve the wear resistance when the bicycle chain is propelled by the tooth ring 20, prolonging the functional life of the crankset 1.

During assembly, the two tooth rings 20 are correspondingly attached to the two side surfaces of the inner ring piece 20, enabling the second engaging portions 24 of the two tooth rings 20 to be respectively embedded into the first engaging portions 13. Consequently, the protruding portions 25 are inserted into the corresponding holes 14, enabling the second engaging surfaces 21 of the two tooth rings 20 to be fixed to the first engaging surfaces 121 of the two sides of the inner ring piece 10 via a friction welding method. Thus, the two tooth rings 20 are tightly engaged with the two sides of the inner ring piece 10, thereby forming the crankset 1 of the present invention.

The two tooth rings 20 are respectively fixed to the two sides of the inner ring piece 10 via a friction welding method to form the crankset 1. Consequently, the overall weight of the crankset 1 can be effectively reduced due to the lightweight inner ring piece 10. The tooth ring 20 is made from a material having a high rigidity, heat resistance and wear resistance, greatly prolonging the functional life of the tooth ring 20. Through the engagement between the first engaging portion 13 and the second engaging portion 14, the structural stability can be effectively enhanced and the twisting force can be greatly improved, making the integral structure of the present invention innovative and convenient.

When assembling the present invention, the two tooth rings 20 are respectively attached to the two sides of the inner ring piece 10, and the corresponding second engaging portion 24 of the two tooth rings 20 are respectively embedded into the first engaging portion 13. Consequently, each protruding portion 25 is respectively inserted into the corresponding hole 14, and the second engaging surface 21 of the two tooth rings 20 are respectively fixed to the two first engaging surface 121 of the inner ring piece 10 via friction welding method.

### Embodiment 2

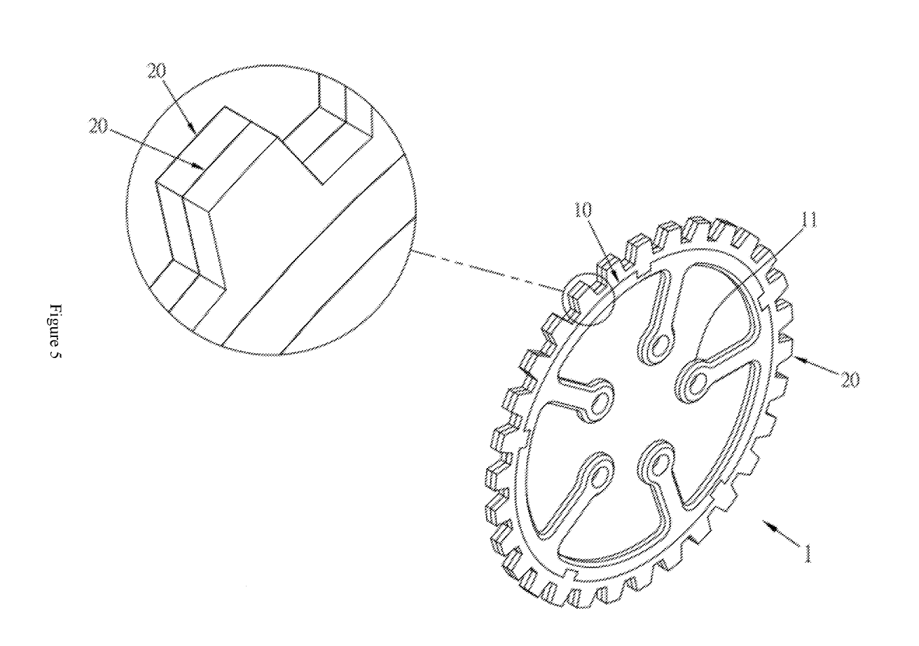

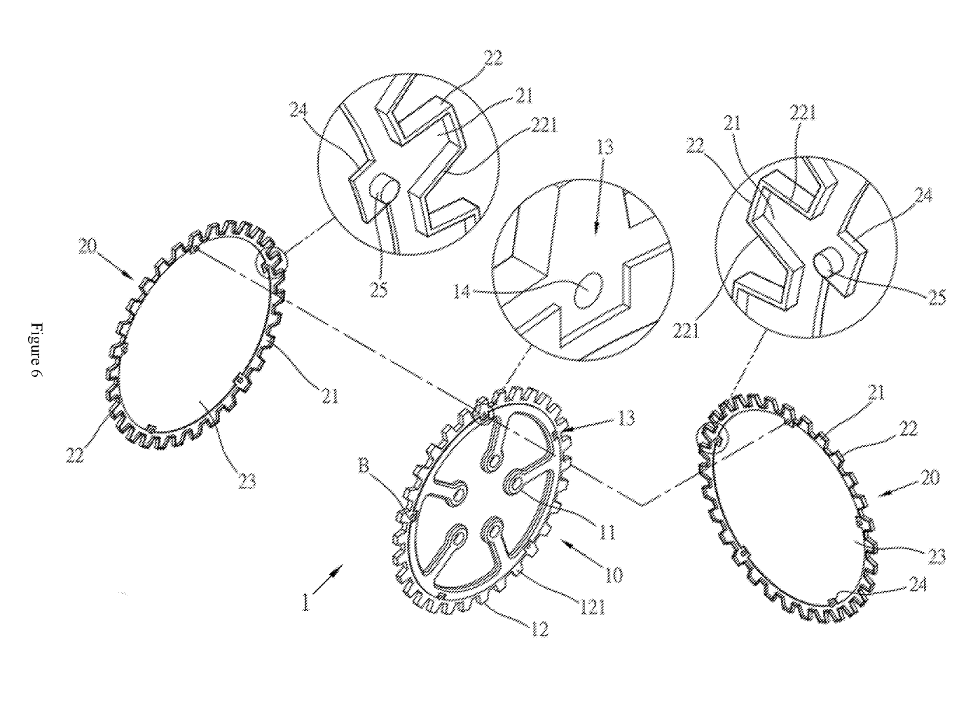

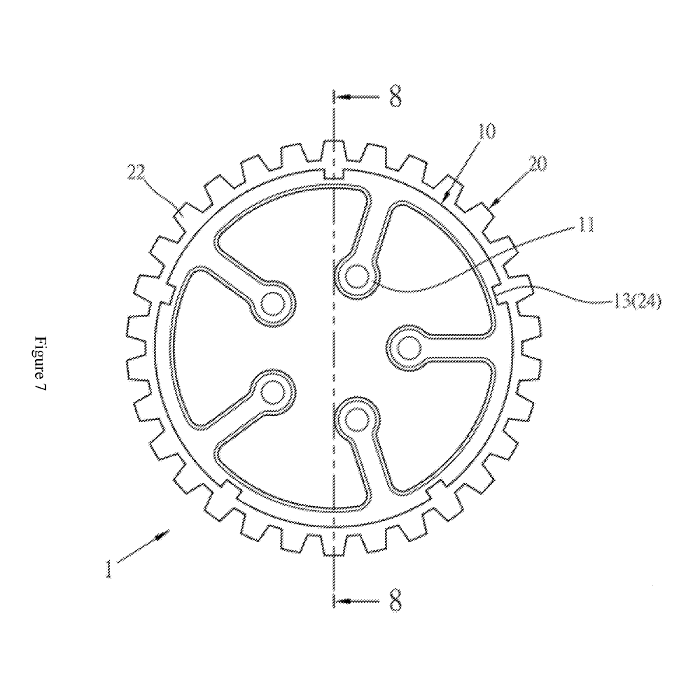

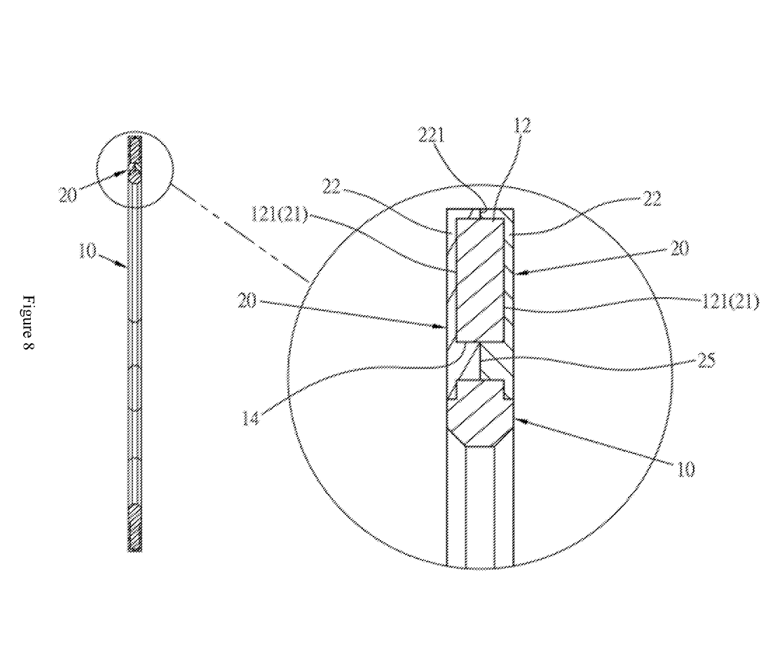

As shown in FIGS. 5-8, the inner ring piece 10 is provided with the first tooth portion 12 having a greater thickness. A side edge 221 is disposed on one side surface of the tooth portion 22 of the tooth ring 20 near the inner ring piece 10. Specifically, the second engaging surface 21 is tightly attached to the first engaging surface 121 of the inner ring piece, and the first tooth portion 12 of the inner ring piece 10 is covered by the side edge 221 of the two sides. The first engaging surface 121 is fixed to the second engaging surface 21 via friction a welding method, significantly improving the binding force and enhancing the structural stability.

During use, the two tooth rings 20 are tightly attached to the two sides of the inner ring piece 10. Consequently, the overall weight of the crankset 1 can be greatly reduced due to the lightweight inner ring piece 10. Meanwhile, the tooth ring 20 is made from a material having high rigidity, wear resistance and heat resistance, all of which greatly prolong the functional life of the tooth ring 20 and lower the replacement frequency of the crankset 1. Thus, the user can feel safe when using the present invention. Furthermore, the outer edge of the two sides of the inner ring piece 10 is provided with a plurality of the inwardly-recessed first engaging portions 13, and the first engaging portion 13 is provided with a hole 14 in the radial direction. Meanwhile, a plurality of the protruding second engaging portion 24 is integrally disposed on the tooth ring 20 near the inner ring hole 23, and one side of each second engaging portion 24 is provided with a protruding portion 25 along the radial direction. During assembly, the corresponding second engaging portions 24 of the two tooth rings 20 are respectively embedded into the first engaging portions 13, and each protruding portion 25 is respectively inserted into the corresponding hole, enabling the second engaging surfaces 21 of the two tooth rings 20 to be tightly attached to the first engaging surface 121 of the inner ring piece 10 via a friction welding method. Specifically, through the engagement between the first engaging portion 13 and the second engaging portion 24, and the engagement between the holes 14 and the protruding portion 25, the twisting force can be greatly improved, thereby achieving a stable structure of the present invention. Furthermore, a side edge 221 is formed on one side surface of the second tooth portion 22 of the tooth ring 20 near the inner ring piece 10. When the second engaging surface 21 is tightly attached to the first engaging surface 121 of the inner ring piece 10, the first tooth portion 12 of the inner ring piece 10 is covered by the side edge 221 of the two sides, which can be further fixed via a friction welding method. Thus, the first tooth portion 12 is fixed to the second tooth portion 22, which effectively improves the binding force so that the present invention can be assembled more securely.

The previous descriptions are of preferred examples for implementing the invention, and the scope of the invention should not necessarily be limited by this description. The scope of the present invention is defined by the claims.

1. A modified vehicle-used crankset composite structure, comprising:
an inner ring piece made from a lightweight metal, wherein the inner surface of the inner ring piece is equally divided and extends to form a plurality of arm-like fixing portions in the radial direction, wherein the outer edge of the inner ring piece is equally divided to form a plurality of the first tooth portions in the radial direction, wherein the two side surfaces of the first tooth portion form a first engaging surface, wherein the modified vehicle-used crankset composite structure further comprises:
a tooth ring made from a rigid, heat-resistant and wear-resistant material, wherein a second engaging surface is disposed on one side surface of the tooth ring, wherein the outer edge of the tooth ring is equally divided to form a plurality of the second tooth portions, wherein an inner ring hole is disposed in the middle of the tooth ring, wherein the two side surfaces of the inner ring piece are respectively pressed by the two tooth rings, enabling the second engaging surfaces to respectively correspond to the first engaging surfaces of the inner ring piece, wherein the inner ring piece and the two tooth rings are fixed via a friction welding method to form the crankset.

2. The modified vehicle-used crankset composite structure of claim 1, wherein a protruding step structure is disposed between the outer edge of the inner ring piece and the first tooth portion of the inner ring piece, wherein the two side surfaces of the first tooth portion of the inner ring piece respectively form a first engaging surface, wherein
a first engaging portion, which is inwardly recessed, is disposed on the outer edge of the two sides of the inner ring piece, wherein a hole is disposed on the first engaging portion in the radial direction, wherein an inner ring hole is disposed in the middle of the tooth ring, wherein a plurality of the protruding second engaging portions is integrally disposed on the tooth ring near the inner ring hole, wherein a plurality of protruding portions is disposed on one side of the second engaging portion along the radial direction, enabling the two side surfaces of the inner ring piece to be pressed by the two tooth rings, wherein the second engaging portion of the two tooth rings is correspondingly engaged with the first engaging portion, and the protruding portion on each side respectively inserts into one side of the corresponding hole, enabling the second engaging surface of the two tooth rings and the first engaging surface of the corresponding side of the inner ring piece to be fixed via friction a welding method.

3. The modified vehicle-used crankset composite structure of claim 1, wherein a side edge is disposed along the radial direction on one side surface of the tooth portion of the tooth ring which faces towards the inner ring piece, wherein the second engaging surface is tightly attached to the first engaging surface, and the first tooth portion of the inner ring piece is covered by the corresponding side edge, enabling the second engaging surface of the two tooth rings and the first engaging surface of the two sides of the inner ring piece, as well as the corresponding side edges, to be fixed via friction welding method.

4. The modified vehicle-used crankset composite structure of claim 1, wherein the inner ring piece is made from a lightweight metal such as aluminum alloy, magnesium alloy or titanium alloy.

5. The modified vehicle-used crankset composite structure of claim 1, wherein the tooth ring is made from stainless steel.

6. The modified vehicle-used crankset composite structure of claim 1, wherein the tooth ring is made from heat-treated steel or iron.

7. The modified vehicle-used crankset composite structure of claim 1, wherein the tooth ring is made from a metal coated with Teflon or other wear-resistant material.
